(19) United States
(12) Patent Application Publication
(10) Pub. No.: US 2024/0002621 A1
(43) Pub. Date: Jan. 4, 2024

(54) eTPE Laser Marking

(71) Applicant: BASF SE, Ludwigshafen am Rhein (DE)

(72) Inventors: Frank THIELBEER, Lemfoerde (DE); Lisa Marie Schmidt, Lemfoerde (DE); Theresa Huelsmann, Lemfoerde (DE); Elmar Poeselt, Lemfoerde (DE); Peter Gutmann, Ludwigshafen am Rhein (DE); Uwe Keppeler, Ludwigshafen am Rhein (DE); Amir Doroodian, Lemfoerde (DE); Florian Tobias Rapp, Ludwigshafen (DE)

(73) Assignee: BASF SE, Ludwigshafen am Rhein (DE)

(21) Appl. No.: 18/247,292

(22) PCT Filed: Sep. 30, 2021
(86) PCT No.: PCT/EP2021/076999

§ 371 Date: Mar. 30, 2023

(30) Foreign Application Priority Data
Oct. 1, 2020 (EP) 20199603.0

(51) Int. Cl. C08J 9/18; C08J 9/12; C08J 9/232; C08J 9/00; C08J 3/20

(52) U.S. Cl. CPC C08J 9/18; C08J 9/122; C08J 9/232; C08J 2203/22; C08J 3/203; C08J 2375/08; C08J 2203/06; C08J 9/0066

(57) ABSTRACT

Laser-markable foamed pellets contain a composition (MI), containing a thermoplastic elastomer (TPE-1) and a color component as component (c1) selected from laser marking additives. A process can be used for producing said laser-markable foamed pellets. The laser-markable foamed pellets according to the present invention can be used for preparing a laser-markable molded body. A process for preparing a laser-markable molded body involves providing and fusing the laser-markable foal led pellets.

The present invention relates to laser-markable foamed pellets comprising a composition (M1) comprising a thermoplastic elastomer (TPE-1) and a color component as component (c1) selected from the group consisting of laser marking additives as well as a process for producing said laser-markable foamed pellets. The present invention further relates to the use of the laser-markable foamed pellets according to the present invention for preparing a laser-markable molded body and a process for preparing a laser-markable molded body from the laser-markable foamed pellets.

Identification marking of products is of increasing importance in almost every branch of industry. By way of example, production data, expiry dates, barcodes, company logos, serial numbers, security features etc. often have to be applied to said products. These markings are often currently still produced by conventional techniques, such as printing, embossing, stamping, and labeling. However, increasing importance is being placed on contactless, very rapid and flexible marking by lasers, in particular for plastics products and plastics packaging. This technique permits high-speed application of identification marks, e.g. graphic inscriptions, such as barcodes. The location of the inscription is within the actual plastic and it is therefore durable, abrasion-resistant, and counterfeit-resistant.

However, laser marking of many elastomers and in particular foamed elastomers such as foamed pellets and moldings prepared from such foamed pellets is difficult or impossible unless they are subjected to additional modification.

It is known that elastomers can be rendered laser-markable by adding appropriate absorbers, e.g. absorbent pigment particles. For example WO 95/30546 A1 describes laser-markable plastics, in particular thermoplastic polyurethanes, which comprise pigments, where these were coated with doped tin dioxide.

For highly elastic, closed-cell foams, such as particle foams made of thermoplastic polyurethane, standard conditions generally cannot be applied since the foam structure is sensible and the temperature in the process has to be controlled. Otherwise, the foam collapses and the mechanical properties of the materials change. Additionally, the surface of the foam is destroyed in this case resulting in a poor visual appearance of the product. In particular when particle foams are used which often have an uneven surface, it is difficult to apply a marking with a sufficient resolution.

Foamed pellets, which are also referred to as particle foams (or bead foams), and molded articles made therefrom, based on thermoplastic polyurethane or other elastomers, are known (for example WO 94/20568, WO 2007/082838 A1, WO2017/030835, WO 2013/153190 A1, WO2010/010010) and can be used in many different ways. For many applications, the application of permanent markings is desirable but respective processes are not available.

A foamed pellet or also a particle foam or particle foam in the sense of the present invention refers to a foam in the form of a particle, the average diameter of the particles being between 0.2 to 20, preferably 0.5 to 15 and in particular between 1 to 12 mm. In the case of non-spherical, e.g. elongated or cylindrical particles mean the longest dimension by diameter.

It was therefore an object of the present invention to provide foamed pellets which can be marked using laser technique and still have good mechanical and visual properties such as 3D structures.

According to the present invention, this object is solved by laser-markable foamed pellets comprising a composition (M1) comprising a thermoplastic elastomer (TPE-1) and a color component as component (c1) selected from the group consisting of laser marking additives.

It was surprisingly found that the addition of laser marking additives to a thermoplastic elastomer results in a composition which can be used to prepare foamed pellets with good mechanical and visual properties and low bulk and part densities which are laser markable and keep their good visual properties such as 3D structures.

Processes for producing foamed pellets from thermoplastic elastomers are known per se to the person skilled in the art. Typically, the bulk density of the foamed pellets is, for example, in the range from 20 g/I to 250 g/I.

It has surprisingly found that composition (M1) comprising a thermoplastic elastomer (TPE-1) and a color component as component (c1) selected from the group consisting of laser marking additives can be extruded and stable foamed pellets can be obtained.

It was found that the use of a color component as component (c1) selected from the group consisting of laser marking additives resulted in foamed pellets and molded bodies prepared from those foamed pellets which could be marked by the use of a laser. If no color component as component (c1) according to the present invention was used, marking with a laser beam did not result in a marking and the laser beam marking resulted in a destruction of the 3D structure.

The foamed pellets of the invention are particularly suitable for identification marking by means of high-energy radiation, in particular by means of lasers. The preferred method of laser inscription is that the specimen is placed in the path of laser radiation, preferably from a pulsed laser. It is preferable to use an Nd-YAG laser. Another possibility is inscription by an excimer laser, e.g. by way of a mask technique. However, the desired results can also be achieved with other conventional types of laser which have a wavelength in a range of high absorption of the absorber used, examples being CO2 lasers. The marking obtained is determined by the irradiation time (or number of pulses in the case of pulsed lasers) and irradiation power level of the laser, and also by the plastics system used. The power level of the lasers used depends on the respective application and can readily be determined by the person skilled in the art in any individual case.

The foamed pellets of the invention or moldings prepared from these can be used in any of the sectors where conventional printing methods have hitherto been used for the inscription of plastics, for example for packaging in the food-and-drinks sector or in the toy sector. Complete label images can be applied durably to multiuse packaging. Another important application sector for laser inscription is provided by plastics tags, known as cattle tags or ear tags, for the individual identification marking of animals. A barcode system is used to store information specific to the animal. This can then be read with the aid of a scanner when required. The inscription has to be very durable because some of the tags remain on the animals for a number of years.

Irradiation to produce an image means here that the irradiation is undertaken specifically only at selected sites, thus preferably permitting production of numerals, letters, or other markings.

The composition (M1) comprises the thermoplastic elastomer and the color component (c1). The composition might contain other components. Typically, the amount of the color component (c1) is adapted to the specific application and might vary in broad ranges. Suitable amounts are for example in the range of from 0.1 to 10% by weight, based on the weight of the composition (M1), preferably in the range of from 0.5 to 5% by weight, in particular in the range of from 1 to 4% by weight, more preferable in the range of from 1.5 to 3% by weight.

According to a further embodiment, the preset invention therefore is directed to laser-markable foamed pellets as disclosed above, wherein the composition (M1) comprises the color component (c1) in an amount in the range of from 0.1 to 10% by weight, based on the weight of the composition (M1).

It has been found that an amount of the color component in the range of from 0.1 to 10% by weight, based on the weight of the composition (M1) is particularly suitable to obtain stable foamed pellets with a homogeneous cell structure.

The color component (c1) used according to the present invention is selected from laser marking additives.

The laser-marking additive is capable of absorbing laser light of a certain wavelength. In practice this wavelength lies between 157 nm and 10.6 micrometer, the customary wavelength range of lasers. If lasers with larger or smaller wavelengths become available, other absorbers may also be considered for application in the additive according to the invention. Examples of such lasers working in the said area are CO₂ lasers (10.6 micrometer), Nd:YAG lasers (1064, 532, 355, 266 nm) vanadat- and excimer lasers of the following wavelengths: F₂ (157 nm), ArF (193 nm), KrCl (222 nm), KrF (248 nm), XeCl (308 nm) and XeF (351 nm), FAYb fiber lasers, diode lasers and diode array lasers. Preferably Nd:YAG lasers and CO₂ lasers are used since these types work in a wavelength range which is very suitable for the induction of thermal processes that are applied for marking purposes.

Molecular and coated laser marking additives can be used according to the present invention. Suitable laser marking additives are generally known to the person skilled in the art.

Suitable laser marking additives include but are not limited to laser-marking additives based on antimony, for example antimony trioxide, as described in WO01/00719. For certain applications it might be advantageous to use antimony-free laser-marking additives as disclosed in EP1190988 such as laser-markable compounds comprising bismuth and at least one additional metal. US2007/02924 describes laser-markable compounds of the formula MOCl, in which M is either As, Sb or Bi, as well as BiONO₃, Bi₂O₂CO₃, BiOOH, BiOF, BiOBr, Bi₂O₃, BiOC₃H₅O₇, Bi(C₇H₅O₂)₃, BiPO₄, Bi₂(SO₄)₃ as additive which can also be used in the composition (M1) according to the present invention.

Furthermore, pigments which are particularly suitable for laser marking are those based on platelet-shaped metal oxides or platelet-shaped substrates, preferably mica, coated with one or more metal oxides. Particularly suitable pigments are those which are distinguished by the fact that the base substrate is first coated with an optionally hydrated silicon dioxide coating before the doped tin dioxide coating is applied. Such pigments are described in DE 38 42 330. In this case, the substrate is suspended in water and the solution of a soluble silicate is added at a suitable pH; if necessary, the pH is kept in the suitable range by simultaneous addition of acid. The silicic acid-coated substrate can be separated off from the suspension before the subsequent coating with the tin dioxide coating and worked up or coated directly with the doped tin dioxide coating.

Furthermore, compounds which are suitable for laser marking in the context of the present invention are also compounds which can be destroyed by application of a suitable laser. In this case the marking might be colored by additional components in the composition which are not affected by the respective laser.

Composition (M1) may comprise further additives such as additional color components. Suitable color components are for example thermochromic colorants, fluorescent dyes including non-visible spectrum fluorescent dyes, phosphorescent dyes, photo-chromic colorants and other optically enhanced color systems to generate a range of different optical effects in high volume consumable products. Furthermore, pigments and dyes can be used according to the present invention.

According to a further embodiment, the preset invention therefore is directed to laser-markable foamed pellets as disclosed above, wherein the composition (M1) comprises at least one component (c2) selected from the group consisting of thermochromic color-change compounds, photochromic color-change compounds, background colorants, colored pigments and dyes.

The addition of the additional component (c2) for example may achieve a contrast on laser marking. However, the concentration of the pigments in the plastic depends on the plastic system employed.

Usually, component (c2) is used in an amount in the range of from 0.1 to 15% by weight, based on the weight of the composition (M1), preferably in a range of from 0.5 to 10% by weight, in particular in the range of from 1 to 5% by weight. According to the present invention it is also possible that the composition (M1) does not contain component (c2).

According to a further embodiment, the preset invention therefore is directed to laser-markable foamed pellets as disclosed above, wherein composition (M1) comprises component (c2) in an amount in the range of from 0.1 to 15% by weight, based on the weight of the composition (M1).

Suitable thermochromic color-change compounds, photochromic color-change compounds, background colorants, colored pigments and dyes are in principle known to the person skilled in the art and are added in suitable amounts depending on the application.

Thermochromic dyes and colorants can be added to the composition formulation to serve as an indicating means to show that a particular composition has been temperature activated for optimal use. Temperature ranges for thermochromic transitions can be below freezing to above boiling depending on the intended use of the thermochromic composition application. Thermochromic dyes can find use in a variety of compositions and applications and formats. Thermochromic dyes can include but are not limited to compounds including: bis(2-amino-4-oxo-6-methylpyrimidinium)-tetrachlorocuprate(II); bis(2-amino-4-chloro-6-methylpyrimidinium) hexa-chlorodicuprate(II); cobalt chloride; 3,5-dinitro salicylic acid; leuco dyes; spiropyrenes, bis(2-amino-4-oxo-6-methylpyrimidinium) tetrachlorocuprate(II) and bis(2-amino-4-chloro-6-methylpyrimidinium) hexachlorodicuprate(II), benzo- and naphthopyrans (Chromenes), poly(xylylviologen dibromide, di-beta-naphthospiropyran, Ferrocene-modified bis(spiropyridopyran), isomers of 1-isopropylidene-2-[1-(2-methyl-5-phenyl-3-thienyl)ethylidene]-succinic anhydride and the Photoproduct 7,7adihydro-4,7,7,7a-tetramethyl-2-phenylbenzo[b]thiophene-5,6-dicarboxylic anhydride, micro-encapsulated dyes, precise melting point compositions, infra-red dyes, spirobenzopyrans, spironnapthooxazines, spirothopyran and related compounds, leuco quinone dyes, natural leuco quinone, traditional leuco quinone, synthetic quinones, thiazine leuco dyes, acylated leuco thiazine dyes, nonacylated leuco thiazine dyes, oxazine leuco dyes, acylated oxazine dyes, nonacylated oxazine leuco dyes, catalytic dyes, combinations with dye developers, arylmethane phthalides, diarylmethane phthalides, monoarylmethane phthalides, monoheterocyclic substituted phthalides, 3-hetercyclic substituted phthalides, diarylmethylazaphthalides, bishetercyclic substituted phthalides, 3,3-bisheterocyclic substituted phthalides, 3-heterocyclic substituted azaphthalides, 3,3-bisheterocyclic substituted azaphthalides, alkenyl substituted phthalides, 3-ethylenyl phthalides, 3,3-bisethylenyl phthalides, 3-butadienyl phthalides, bridged phthalides, spirofluorene phthalides, spirobensanthracene phthalides, bisphthalides, di and triarylmethanes, diphenylmethanes, carbinol bases, pressure sensitive recrcording chemistries, photosensitive recording chemistries, fluoran compounds, reaction of keto acids and phenols, reactions of keto acids with 4-alkoxydiphenylamines, reactions of keto acids sith 3-alkoxdiphenylamines, reactions of 2′-aminofluorans with aralkyl halides, reaction of 3′-chlorofluorans with amines, thermally sensitive recording mediums, tetrazolium salts, tetrazolium salts from formazans, tetrazolium salts from tetazoles, and the like.

Other thermochromic dyes of interest include leucodyes including color to colorless and color to color formulations, vinylphenylmethane-leucocynides and derivatives, fluoran dyes and derivatives, thermochromic pigments, micro and nano-pigments, molybdenum compounds, doped or undoped vanadium dioxide, indolinospirochromenes, melting waxes, encapsulated dyes, liquid crystalline materials, cholesteric liquid crystalline materials, spiropyrans, polybithiophenes, bipyridine materials, microencapsulated, mercury chloride dyes, tin complexes, combination thermochromic/photochromic materials, heat formable materials which change structure based on temperature, natural thermochromic materials such as pigments in beans, various thermochromic inks commercially available from Segan Industries, Inc., (Burlingame, Calif.), Matsui International Corp. (Gardena Calif.), Liquid Crystal Research Crop. (Chicago Il), or any acceptable thermochromic materials with the capacity to report a temperature change or can be photo-stimulated and the like. The chromic change agent selected will depend on a number of factors including cost, material loading, color change desired, levels or color hue change, re-versibility or irreversibility, stability, and the like.

Alternative thermochromic materials can be utilized including, but not limited to: light-induced metastable state in a thermochromic copper (II) complex Chem. Commun., 2002, (15), 1578-1579 under goes a color change from red to purple for a thermochromic complex, [Cu(dieten)2](BF4)2 (dieten=N,N-diethylethylenediamine); encapsulated pigmented materials from Omega Engineering Inc.; bis(2-amino-4-oxo-6-methyl-pyrimidinium)-tetrachlorocuprate(II); bis(2-amino-4-chloro-6-methylpyrimidinium) hexachlorod-icuprate(II); cobalt chloride; 3,5-dinitro salicylic acid; leuco dyes; spiropyrenes, bis(2-amino-4-oxo-6-methylpyrimidinium)-tetrachlorocuprate(II); bis(2-amino-4-chloro-6-methylpyrimidinium) hexachlorod-icuprate(II); cobalt chloride; 3,5-dinitro salicylic acid; leuco dyes; spiropyrenes, bis(2-amino-4-oxo-6-methylpyrimidinium) tetrachlorocuprate(II) and bis(2-amino-4-chloro-6-methylpyrimidinium) hexachlorodicuprate(II), benzo- and naphthopyrans (Chromenes), poly(xylylviologen dibromide, dibeta-naphthospiropyran, Ferrocene-modified bis(spiropyridopyran), isomers of 1-isopropylidene-2-[1-(2-methyl-5-phenyl-3-thienyl)ethylidene]-succinic anhydride and the Photoproduct 7,7adihydro-4,7,7,7a-tetramethyl-2-phenylbenzo[b]thiophene-5,6-dicarboxylic anhydride, and the like. Encapsulated leuco dyes are of interest since they can be easily processed in a variety of formats into a plastic or putty matrix. Liquid crystal materials can be conveniently applied as paints or inks to surfaces of color/shape/memory composites.

Thermochromic color to colorless options can include by way of example, but not by limitation: yellow to colorless, orange to color less, red to colorless, pink to colorless, magenta to colorless, purple to colorless, blue to colorless, turquoise to colorless, green to colorless, brown to colorless, black to colorless. Color to color options include but are not limited to: orange to yellow, orange to pink, orange to very light green, orange to peach; red to yellow, red to orange, red to pink, red to light green, red to peach; magenta to yellow, magenta to orange, magenta to pink, magenta to light green, magenta to light blue; purple to red, purple to pink, purple to blue; blue to pink; blue to light green, dark blue to light yellow, dark blue to light green, dark blue to light blue; turquoise to light green, turquoise to light blue, turquoise to light yellow, turquoise to light peach, turquoise to light pink; green to yellow, dark green to orange, dark green to light green, dark green to light pink; brown and black to a variety of assorted colors, and the like. Colors can be deeply enriched using fluorescent and glow-in-the-dark or photo-luminescent pigments as well as related color additives.

Reversible and irreversible versions of the color change agent can be employed depending on the desired embodiment of interest. Reversible agents can be employed where it is desirable to have a multi-use effect or reuse the color change effect. For example, products with continued and repeated use value will find utility of a reversible color change component comprising the final embodiment. In this case it would be desirable to utilize a reversible thermochromic or luminescent material which can be repeated during usage. In another example, it may be desirable to record a single color change permanently. In this case, it would be desirable to utilize a thermochromically irreversible material which changes from one color to another giving rise to a permanent change and indicating that the composition should be discarded after use.

Color change rainbow effect in consumable consumer products can be accomplished by carefully admixing more than one thermochromic component. Disparity in thermochromic composition transition temperatures in combination with 2 or more thermochromic combinations can be used to achieve a patterned, rainbow, spectral, gradient, or sequential coloration effect.

Random color generating pigments can be utilized. Color bursts or random color generating encapsulating pigmented injection molding and extrusion master batch materials can be generated by particle size, dispersion capabilities of the carrier during melting and in process and the like.

Non-microencapsulated and micro-encapsulated thermochromic additives can be added to product substrate compositions from between 0.1% to 10% depending on the application and utility of the multi-element additive. Typically, the additive will be added from between 0.05% and 25% by weight to the product matrix. More often, the additive will be included from between 0.1% and 20% by weight. Most often, the additive will find use at between 1% and 10% by weight.

Photochromic materials of interest as component (c2) can be either organic compounds, such as anils, disulfoxides, hydrazones, osazones, semicarbazones, stilbene derivatives, o-nitrobenzyl derivatives, spiro compounds, and the like, and in inorganic compounds, such as metal oxides, alkaline earth metal sulfides, titanates, mercury compounds, copper compounds, minerals, transition metal compounds such as carbonyls, and the like. Inks containing photochromic components could be used as a security ink, watermark or to create some other means for authenticating a document.

Examples of suitable photochromic materials include compounds that undergo heterolytic cleavage, such as spiropyrans and related compounds, and the like; compounds that undergo homolytic cleavage, such as bis-imidazole compounds, bis-tetraphenylpyrrole, hydrazine compounds, aryl disulfide compounds, and the like; compounds that undergo cis-trans isomerization, such as stilbene compounds, photoisomerizable azo compounds, and the like; compounds that undergo photochromic tautomerism, including those that undergo hydrogen transfer phototautomerism, those that undergo photochromic valence tautomerism, and the like; and others. Mixtures of two or more photochromic materials may be used together in any suitable ratio.

Specific examples of photochromic materials include spiropyrans such as spiro[2H-1-benzopyran-2,2′-indolines], spirooxazines such as spiro[indoline-2,3′-[3H]-naphtho[2,1-b]-1,4-oxazines], spirothiopyrans such as piro[2H-1-benzothiopyran-2,2′-indolines], stilbene compounds, aromatic azo compounds, bisimidazoles, hydrazines, aryl disulfides, and mixtures thereof may also be used, azo compounds that exhibit photochromism, bisimidazoles, benzo and naphthopyrans (chromenes) such as 3,3-diphenyl-3H-naphtho[2,1-b] pyran; 2-methyl-7,7-diphenyl-7H-pyrano-[2,3-g]-benzothyazole; 2,2′-spiroadamantylidene-2H-naphtho-[1,2-b] pyran, spirodihydroindolizines and related systems (tetrahydro- and hexahydroindolizine such as 4,5-dicarbomethoxy-3H-pyrazole-(3-spiro-9)-fluorene; 1′H-2′,3′-6 tricarbomethoxy-spiro(fluorine-9-1′-pyrrolo[1,2-b]-pyridazine]; 1′H-2′,3′-dicyano-7-methoxy-carbonyl-spiro[fluorine-9,1′-pyrrolo-[1,2-b]p-yridine, quinines such as 1-phenoxy-2,4-dioxyanthraquinone; 6-phenoxy-5,12-naphthacenequinone; 6-phenoxy-5,12-pentacenequinone; 1,3-dichloro-6-phenoxy-7,12-phthaloylpyrene, perimidinespirocyclohexadienones such as 2,3-dihydro-2-spiro-4′-(2′,6′-di-tert-butylcyclohexadien-2′,5′-one)-perim-idine; 1-methyl-2,3-dihydro-2-spiro-4′-(2′,6′-di-tert-butylcyclohexadien-2-′,5′-one)-perimidine; 2,3-dihydro-2-spiro-4′-[(4H)-2′-tert-butylnaphthalen-1′-one]perimidine; 5,7,9-trimethyl-2,3-dihydro-2-spiro-4′-(2′,6′-di-tert-butylcyclohexadien-2′,5′-one)-pyrido-[4,3,2,d,e] quinazoline, perimidinespirocyclohexadienones, photochromic viologens such as N,N′-dimethyl-4,4′-bipyridinium dichloride; N,N′-diethyl-4,4′-bipyridinium dibromide; N-phenyl, N′-methyl-4,4,-bipyridinium dichloride, fulgides and fulgimides such as -(p-methoxyphenyl)-ethylidene (isopropylidene) succinic anhydride; 2-[1-(2,5-dimethyl-3-furyl)-2-methylpropylidene]-3-isopropylidene succinic anhydride; (1,2-dimethyl-4-isopropyl-5-phenyl)-3-pyrryl ethylidene (isopropylidene) succinic anhydride, diarylethenes such as 1,2-bis-(2,4-dimethylthiophen-3-yl) perfluorocyclopentene; 1,2-bis-(3,5-dimethylthiophen-3-yl) perfluorocyclopentene; and 1,2-bis-(2,4-diphenylthiophen-3-yl) perfluorocyclopentene, triarylmethanes, Anils and related compounds, and hydrazines.

Also suitable are compounds that exhibit tautomeric photochromic phenomena. Examples of these materials include those that undergo photochromic valence tautomerism, those that undergo hydrogen transfer, including keto-enol phototautomerism, aci-nitro phototautomerism, and those that undergo other forms of phototautomerism, such as the naphthacenequinones and their substituted derivatives, as well as polymers containing these moieties, which undergo photochromic transformation between the trans and ana forms, for example as described in, for example, F. Buchholtz et al., Macromolecules, vol. 26, p. 906 (1993), the disclosure of which is totally incorporated herein by reference. Mixtures of any of the foregoing photochromic materials may also be used.

In addition, mineral photochromic compounds can be selected and utilized from the metal oxides, hydrates of said oxides and their complexes such as those described in the patent U.S. Pat. No. 5,989,573 and EP 0 359 909 B1 and in particular the oxides of titanium, niobium, silicon, aluminum, zinc, hafnium, thorium, tin, thallium, zirconium, beryllium, cobalt, calcium, magnesium, iron and their mixtures. Of these metal oxides, particular mention may be made of the oxides of titanium, aluminum, zinc, zirconium, calcium, magnesium, silicon and iron. The oxides and oxide hydrates of titanium, aluminum, zinc, zirconium, calcium and magnesium are preferred. Even more preferably use should be made of titanium dioxide which can be made photochromic with the aid of a metal selected from iron, chromium, copper, nickel, manganese, cobalt, molybdenum as such or in the form of a salt such as a sulfate, chlorate, nitrate, acetate.

Luminescent, glow-in-the dark, security, pearlescent, pigments visible only under UV light, or fluorescent pigments can be used in conjunction with other additive compositions. Non-visible spectrum fluorescent dyes can be obscured by an one color of a diacetylenic composition or other thermochromic dye such that when a temperature triggering event occurs, the fluorescent signal becomes visible when utilizing the corresponding wavelength to reveal the fluorescent dye composition.

Pearlescent or nacreous pigments have become popular in the creation of luster effects in coatings. This has enabled the generation of new and unique color effects for automotive, industrial, cosmetic and pharmaceutical applications.

Pigments, additives, augmenting agents, colorants, and related compositions described can added in powered forms, added in master batch forms, added as dry pseudo master batch forms, liquid master batch forms or the like. The method or choice of addition depends on the process utilized for production and the best method for additive introduction. Pelleted master batch find use with conventional extrusion and injection molding processes. Liquid master batch forms can be utilized with continuous addition processes typically used for plastics extrusion. Powdered forms can find use where equipment can be modified to accommodate fines and powder density.

The components (c1) and (c2) are usually mixed with the thermoplastic elastomer (TPE-1) using suitable methods known to the person skilled in the art.

According to the present invention, the composition (M1) comprises the thermoplastic elastomer (TPE-1). Suitable thermoplastic elastomers for producing the foams or moldings according to the invention are known per se to the person skilled in the art. Suitable thermoplastic elastomers are described, for example, in “Handbook of Thermoplastic Elastomers”, 2nd edition June 2014. For example, the thermoplastic elastomer (TPE-1) can be a thermoplastic polyurethane, a thermoplastic polyether amide, a polyether ester, a polyester ester, a thermoplastic elastomer based on polyolefin, a crosslinked thermoplastic elastomer based on polyolefin or a thermoplastic vulcanizate or a thermoplastic styrene butadiene block copolymer. According to the invention, the thermoplastic elastomer (TPE-1) can preferably be a thermoplastic polyurethane, a thermoplastic polyether amide, a polyether ester, or a polyester ester.

According to a further embodiment, the preset invention therefore is directed to laser-markable foamed pellets as disclosed above, wherein the thermoplastic elastomer is selected from the group consisting of thermoplastic polyurethane, a thermoplastic polyether amide, a polyether ester, a polyester ester, a thermoplastic elastomer based on olefin, a crosslinked thermoplastic elastomer based on olefin or a thermoplastic vulcanizate or a thermoplastic styrene butadiene block copolymers and mixtures thereof.

In the context of the present invention, the thermoplastic elastomer (TPE-1) is further preferably a thermoplastic polyurethane, a thermoplastic polyether amide or a polyester ester or polyether ester.

Suitable production processes for these thermoplastic elastomers or foams or foamed granules from the thermoplastic elastomers mentioned are likewise known to the person skilled in the art.

Particularly suitable thermoplastic elastomers (TPE-1) are thermoplastic polyurethanes. Also thermoplastic polyurethanes are well known. They are produced by reaction of isocyanates with isocyanate-reactive compounds for example polyols with number-average molar mass from 500 g/mol to 5 000 g/mol and optionally chain extenders with molar mass from 50 g/mol to 499 g/mol, optionally in the presence of catalysts and/or conventional auxiliaries and/or additional substances.

For the purposes of the present invention, preference is given to thermoplastic polyurethanes obtainable via reaction of isocyanates with isocyanate-reactive compounds for example polyols with number-average molar mass from 500 g/mol to 5 000 g/mol and a chain extender with molar mass from 50 g/mol to 499 g/mol, optionally in the presence of catalysts and/or conventional auxiliaries and/or additional substances.

The isocyanate, isocyanate-reactive compounds for example polyols and, if used, chain extenders are also, individually or together, termed structural components. The structural components together with the catalyst and/or the customary auxiliaries and/or additional substances are also termed starting materials.

The molar ratios of the quantities used of the polyol component can be varied in order to adjust hardness and melt index of the thermoplastic polyurethanes, where hardness and melt viscosity increase with increasing content of chain extender in the polyol component at constant molecular weight of the TPU, whereas melt index decreases.

For production of the thermoplastic polyurethanes, isocyanates and polyol component, where the polyol component in a preferred embodiment also comprises chain extenders, are reacted in the presence of a catalyst and optionally auxiliaries and/or additional substances in amounts such that the equivalence ratio of NCO groups of the diisocyanates to the entirety of the hydroxyl groups of the polyol component is in the range from 1:0.8 to 1:1.3.

Another variable that describes this ratio is the index. The index is defined via the ratio of all of the isocyanate groups used during the reaction to the isocyanate-reactive groups, i.e. in particular the reactive groups of the polyol component and the chain extender. If the index is 1000, there is one active hydrogen atom for each isocyanate group. At indices above 1000, there are more isocyanate groups than isocyanate-reactive groups.

An equivalence ratio of 1:0.8 here corresponds to an index of 1250 (index 1000=1:1), and a ratio of 1:1.3 corresponds to an index of 770.

In a preferred embodiment, the index in the reaction of the abovementioned components is in the range from 965 to 1110, preferably in the range from 970 to 1110, particularly preferably in the range from 980 to 1030, and also very particularly preferably in the range from 985 to 1010.

Preference is given in the invention to the production of thermoplastic polyurethanes where the weight-average molar mass (M_{w}) of the thermoplastic polyurethane is at least 60 000 g/mol, preferably at least 80 000 g/mol and in particular greater than 100 000 g/mol. The upper limit of the weight-average molar mass of the thermoplastic polyurethanes is very generally determined by processability, and also by the desired property profile. The number-average molar mass of the thermoplastic polyurethanes is preferably from 80 000 to 300 000 g/mol. The average molar masses stated above for the thermoplastic polyurethane, and also for the isocyanates and polyols used, are the weight averages determined by means of gel permeation chromatography (e.g. in accordance with DIN 55672-1, March 2016).

Organic isocyanates that can be used are aliphatic, cycloaliphatic, araliphatic and/or aromatic isocyanates.

Aliphatic diisocyanates used are customary aliphatic and/or cycloaliphatic diisocyanates, for example tri-, tetra-, penta-, hexa-, hepta- and/or octamethylene diisocyanate, 2-methylpentamethylene 1,5-diisocyanate, 2-ethyltetramethylene 1,4-diisocyanate, hexamethylene 1,6-diisocyanate (HDI), pentamethylene 1,5-diisocyanate, butylene 1,4-diisocyanate, trimethylhexamethylene 1,6-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, methylenedicyclohexyl 4,4′-, 2,4′- and/or 2,2′-diisocyanate (H12MDI).

Suitable aromatic diisocyanates are in particular naphthylene 1,5-diisocyanate (NDI), tolylene 2,4- and/or 2,6-diisocyanate (TDI), 3,3′-dimethyl-4,4′-diisocyanatobiphenyl (TODD, p phenylene diisocyanate (PDI), diphenylethane 4,4′-diisoyanate (EDI), methylenediphenyl diisocyanate (MDI), where the term MDI means diphenylmethane 2,2′, 2,4′- and/or 4,4′-diisocyanate, 3,3′-10 dimethyldiphenyl diisocyanate, 1,2-diphenylethane diisocyanate and/or phenylene diisocyanate

Mixtures can in principle also be used. Examples of mixtures are mixtures comprising at least a further methylenediphenyl diisocyanate alongside methylenediphenyl 4,4′-diisocyanate. The term “methylenediphenyl diisocyanate” here means diphenylmethane 2,2′-, 2,4′- and/or 4,4′-diisocyanate or a mixture of two or three isomers. It is therefore possible to use by way of example the following as further isocyanate: diphenylmethane 2,2′- or 2,4′-diisocyanate or a mixture of two or three isomers. In this embodiment, the polyisocyanate composition can also comprise other abovementioned polyisocyanates.

Other examples of mixtures are polyisocyanate compositions comprising 4,4′-MDI and 2,4′-MDI, or 4,4′-MDI and 3,3′-dimethyl-4,4′-diisocyanatobiphenyl (TODI) or 4,4′-MDI and H12MDI (4,4′-methylene dicyclohexyl diisocyanate) or 4,4′-MDI and TDI; or 4,4′-MDI and 1,5-naphthylene diisocyanate (NDI).

In accordance with the invention, three or more isocyanates may also be used. The polyisocyanate composition commonly comprises 4,4′-MDI in an amount of from 2 to 50%, based on the entire polyisocyanate composition, and the further isocyanate in an amount of from 3 to 20%, based on the entire polyisocyanate composition.

Crosslinkers can be used as well, moreover, examples being the aforesaid higher-functionality polyisocyanates or polyols or else other higher-functionality molecules having a plurality of isocyanate-reactive functional groups. It is also possible within the realm of the present invention for the products to be crosslinked by an excess of the isocyanate groups used, in relation to the hydroxyl groups. Examples of higher-functionality isocyanates are triisocyanates, e.g. triphenylmethane 4,4′,4″-triisocyanate, and also isocyanurates, and also the cyanurates of the aforementioned diisocyanates, and the oligomers obtainable by partial reaction of diisocyanates with water, for example the biurets of the aforementioned diisocyanates, and also oligomers obtainable by controlled reaction of semiblocked diisocyanates with polyols having an average of more than two and preferably three or more hydroxyl groups.

The amount of crosslinkers here, i.e. of higher-functionality isocyanates and higher-functionality polyols, ought not to exceed 3% by weight, preferably 1% by weight, based on the overall mixture of components.

The polyisocyanate composition may also comprise one or more solvents. Suitable solvents are known to those skilled in the art. Suitable examples are nonreactive solvents such as ethyl acetate, methyl ethyl ketone and hydrocarbons.

Isocyanate-reactive compounds are those with molar mass that is preferably from 500 g/mol to 5000 g/mol, more preferably from 500 g/mol to 3000 g/mol, in particular from 500 g/mol to 2500 g/mol.

The statistical average number of hydrogen atoms exhibiting Zerewitinoff activity in the isocyanate-reactive compound is at least 1.8 and at most 2.2, preferably 2; this number is also termed the functionality of the isocyanate-reactive compound (b), and states the quantity of isocyanate-reactive groups in the molecule, calculated theoretically for a single molecule, based on a molar quantity. The isocyanate-reactive compound preferably is substantially linear and is one isocyanate-reactive substance or a mixture of various substances, where the mixture then meets the stated requirement.

The ratio of polyols and chain extender used is varied in a manner that gives the desired hard-segment content, which can be calculated by the formula disclosed in WO2018/087362A1. A suitable hard segment content here is below 60%, preferably below 40%, particularly preferably 25%.

The isocyanate-reactive compound preferably has a reactive group selected from the hydroxy group, the amino groups, the mercapto group and the carboxylic acid group. Preference is given here to the hydroxy group and very particular preference is given here to primary hydroxy groups. It is particularly preferable that the isocyanate-reactive compound (b) is selected from the group of polyesterols, polyetherols and polycarbonatediols, these also being covered by the term “polyols”.

Suitable polymers in the invention are homopolymers, for example polyetherols, polyesterols, polycarbonatediols, polycarbonates, polysiloxanediols, polybutadienediols, and also block co-polymers, and also hybrid polyols, e.g. poly(ester/amide). Preferred polyetherols in the invention are polyethylene glycols, polypropylene glycols, polytetramethylene glycol (PTHF), polytrimethylene glycol. Preferred polyester polyols are polyadipates, polysuccinic esters and polycaprolactones.

In another embodiment, the present invention also provides a thermoplastic polyurethane as described above where the polyol composition comprises a polyol selected from the group consisting of polyetherols, polyesterols, polycaprolactones and polycarbonates.

Examples of suitable block copolymers are those having ether and ester blocks, for example polycaprolactone having polyethylene oxide or polypropylene oxide end blocks, and also polyethers having polycaprolactone end blocks. Preferred polyetherols in the invention are polyethylene glycols, polypropylene glycols, polytetramethylene glycol (PTHF) and polytrimethylene glycol. Preference is further given to polycaprolactone.

In a particularly preferred embodiment, the molar mass Mn of the polyol used is in the range from 500 g/mol to 5000 g/mol, preferably in the range from 500 g/mol to 3000 g/mol.

Another embodiment of the present invention accordingly provides a thermoplastic polyurethane as described above where the molar mass Mn of at least one polyol comprised in the polyol composition is in the range from 500 g/mol to 5000 g/mol.

It is also possible in the invention to use mixtures of various polyols.

An embodiment of the present invention uses, for the production of the thermoplastic polyurethane, at least one polyol composition comprising at least polytetrahydrofuran. The polyol composition in the invention can also comprise other polyols alongside polytetrahydrofuran.

Materials suitable by way of example as other polyols in the invention are polyethers, and also polyesters, block copolymers, and also hybrid polyols, e.g. poly(ester/amide). Examples of suitable block copolymers are those having ether and ester blocks, for example polycaprolactone having polyethylene oxide or polypropylene oxide end blocks, and also polyethers having polycaprolactone end blocks. Preferred polyetherols in the invention are polyethylene glycols and polypropylene glycols. Preference is further given to polycaprolactone as other polyol.

Examples of suitable polyols are polyetherols such as polytrimethylene oxide and polytetramethylene oxide.

Another embodiment of the present invention accordingly provides a thermoplastic polyurethane as described above where the polyol composition comprises at least one polytetrahydrofuran and at least one other polyol selected from the group consisting of another polytetramethylene oxide (PTHF), polyethylene glycol, polypropylene glycol and polycaprolactone.

In a particularly preferred embodiment, the number-average molar mass Mn of the polytetrahydrofuran is in the range from 500 g/mol to 5000 g/mol, more preferably in the range from 550 to 2500 g/mol, particularly preferably in the range from 650 to 2000 g/mol and very preferably in the range from 650 to 1400 g/mol.

The composition of the polyol composition can vary widely for the purposes of the present invention. By way of example, the content of the first polyol, preferably of polytetrahydrofuran, can be in the range from 15% to 85%, preferably in the range from 20% to 80%, more preferably in the range from 25% to 75%.

The polyol composition in the invention can also comprise a solvent. Suitable solvents are known per se to the person skilled in the art.

Insofar as polytetrahydrofuran is used, the number-average molar mass Mn of the polytetrahydrofuran is by way of example in the range from 500 g/mol to 5000 g/mol, preferably in the range from 500 to 3000 g/mol. It is further preferable that the number-average molar mass Mn of the polytetrahydrofuran is in the range from 500 to 1400 g/mol.

The number-average molar mass Mn here can be determined as mentioned above by way of gel permeation chromatography.

Another embodiment of the present invention also provides a thermoplastic polyurethane as described above where the polyol composition comprises a polyol selected from the group consisting of polytetrahydrofurans with number-average molar mass Mn in the range from 500 g/mol to 5000 g/mol.

It is also possible in the invention to use mixtures of various polytetrahydrofurans, i.e. mixtures of polytetrahydrofurans with various molar masses.

Chain extenders used are preferably aliphatic, araliphatic, aromatic and/or cycloaliphatic compounds with a molar mass from 50 g/mol to 499 g/mol, preferably having 2 isocyanate-reactive groups, also termed functional groups. Preferred chain extenders are diamines and/or alkanediols, more preferably alkanediols having from 2 to 10 carbon atoms, preferably having from 3 to 8 carbon atoms in the alkylene moiety, these more preferably having exclusively primary hydroxy groups.

Preferred embodiments use chain extenders, these being preferably aliphatic, araliphatic, aromatic and/or cycloaliphatic compounds with molar mass from 50 g/mol to 499 g/mol, preferably having 2 isocyanate-reactive groups, also termed functional groups. It is preferable that the chain extender is at least one chain extender selected from the group consisting of ethylene 1,2-glycol, propane-1,2-diol, propane-1,3-diol, butane-1,4-diol, butane-2,3-diol, pentane-1,5-diol, hexane-1,6-diol, diethylene glycol, dipropylene glycol, cyclohexane-1,4-diol, cyclohexane-1,4-dimethanol, neopentyl glycol and hydroquinone bis(beta-hydroxyethyl) ether (HQEE). Particularly suitable chain extenders are those selected from the group consisting of 1,2-ethanediol, propane-1,3-diol, butane-1,4-diol and hexane-1,6-diol, and also mixtures of the abovementioned chain extenders. Examples of specific chain extenders and mixtures are disclosed inter alia in WO 2018/087362A1.

In preferred embodiments, catalysts are used with the structural components. These are in particular catalysts which accelerate the reaction between the NCO groups of the isocyanates and the hydroxy groups of the isocyanate-reactive compound and, if used, the chain extender.

Examples of catalysts that are further suitable are organometallic compounds selected from the group consisting of organyl compounds of tin, of titanium, of zirconium, of hafnium, of bismuth, of zinc, of aluminum and of iron, examples being organyl compounds of tin, preferably dialkyltin compounds such as dimethyltin or diethyltin, or tin-organyl compounds of aliphatic carboxylic acids, preferably tin diacetate, tin dilaurate, dibutyltin diacetate, dibutyltin dilaurate, bismuth compounds, for example alkylbismuth compounds or the like, or iron compounds, preferably iron(III) acetylacetonate, or the metal salts of carboxylic acids, e.g. tin(II) isooctanoate, tin dioctanoate, titanic esters or bismuth(III) neodecanoate. Particularly preferred catalysts are tin dioctanoate, bismuth decanoate and titanic esters. Quantities preferably used of the catalyst are from 0.0001 to 0.1 part by weight per 100 parts by weight of the isocyanate-reactive compound. Other compounds that can be added, alongside catalysts, to the structural components are conventional auxiliaries. Mention may be made by way of example of surface-active substances, fillers, flame retardants, nucleating agents, oxidation stabilizers, lubricating and demolded body aids, dyes and pigments, and optionally stabilizers, preferably with respect to hydrolysis, light, heat or discoloration, inorganic and/or organic fillers, reinforcing agents and/or plasticizers.

Suitable dyes and pigments are listed at a later stage below. The additives mentioned are suitable additives for the thermoplastic elastomers used according to the present invention in particular for thermoplastic polyurethanes, thermoplastic polyether amides, polyether esters, polyester esters, thermoplastic elastomers based on olefins, crosslinked thermoplastic elastomers based on olefins or thermoplastic vulcanizates or thermoplastic styrene butadiene block copolymers and mixtures thereof.

Stabilizers for the purposes of the present invention are additives which protect a plastic or a plastics mixture from damaging environmental effects. Examples are primary and secondary antioxidants, sterically hindered phenols, hindered amine light stabilizers, UV absorbers, hydrolysis stabilizers, quenchers and flame retardants. Examples of commercially available stabilizers are found in Plastics Additives Handbook, 5th edn., H. Zweifel, ed., Hanser Publishers, Munich, 2001 ([1]), pp. 98-136.

The thermoplastic polyurethanes may be produced batchwise or continuously by the known processes, for example using reactive extruders or the belt method by the “one-shot” method or the prepolymer process, preferably by the “one-shot” method. In the “one-shot” method, the components to be reacted, and in preferred embodiments also the chain extender in the polyol component, and also catalyst and/or additives, are mixed with one another consecutively or simultaneously, with immediate onset of the polymerization reaction. The TPU can then be directly pelletized or converted by extrusion to lenticular pellets. In this step, it is possible to achieve concomitant incorporation of other adjuvants or other polymers.

In the extruder process, structural components, and in preferred embodiments also the chain extender, catalyst and/or additives, are introduced into the extruder individually or in the form of mixture and reacted, preferably at temperatures of from 100° C. to 280° C., preferably from 140° C. to 250° C. The resultant polyurethane is extruded, cooled and pelletized, or directly pelletized by way of an underwater pelletizer in the form of lenticular pellets.

In a preferred process, a thermoplastic polyurethane is produced from structural components isocyanate, isocyanate-reactive compound including chain extender, and in preferred embodiments the other raw materials in a first step, and the additional substances or auxiliaries are incorporated in a second extrusion step.

It is preferable to use a twin-screw extruder, because twin-screw extruders operate in force-conveying mode and thus permit greater precision of adjustment of temperature and quantitative output in the extruder. Production and expansion of a TPU can moreover be achieved in a reactive extruder in a single step or by way of a tandem extruder by methods known to the person skilled in the art.

According to the present invention, composition (M1) comprises the thermoplastic elastomer (TPE-1). The composition may comprise further components such as further thermoplastic elastomers or fillers. In the context of the present invention, the term fillers encompass organic and inorganic fillers such as for example further polymers.

The composition (M1) may comprise the thermoplastic elastomer (TPE-1) in an amount in the range of from 70 to 99.9 wt.-% based on the weight of the composition (M1), preferably in the range of from 80 to 98 wt.-% based on the weight of the composition (M1), particularly preferable in the range of from 90 to 97 wt.-% based on the weight of the composition (M1).

The sum of the components of composition (M1) adds up to 100 wt.-% unless otherwise noted.

Methods for preparing foamed pellets based on thermoplastic elastomers are generally known to the person skilled in the art.

According to a further aspect, the present invention is also directed to a process for producing laser-markable foamed pellets as disclosed above, the process comprising
(i) mixing a thermoplastic elastomer (TPE-1) and a color component (c1) selected from the group consisting of laser marking additives to obtain a composition (M1) and
(ii) preparing foamed pellets comprising the composition (M1).

In principle, suitable methods for steps (i) and (ii) are known to the person skilled in the art. Suitable methods for mixing a thermoplastic elastomer (TPE-1) and a color component (c1) to obtain a composition (M1) include for example mixing the components in an extruder.

The laser-markable foamed pellets according to the present invention can be used to prepare laser markable molded bodies. Molded bodies prepared from the laser-markable foamed pellets according to the present invention have good mechanical properties such as for example a high rebound.

According to a further aspect, the present invention is also directed to the use of the laser-markable foamed pellets according to the present invention for preparing a laser-markable molded body.

Processes for preparing molded bodies from foamed pellets are generally known to the person skilled in the art.

The molded bodies according to the present invention are suitable for different applications.

According to a further embodiment, the preset invention therefore is directed the use of laser-markable foamed pellets as disclosed above, wherein the laser-markable body is suitable for security applications, in particular security tagging.

Laser marking and/or messaging can be accomplished in different formats depending on the laser wave length, power or intensity, frequency utilized, additives to the consumable product utilized, speed at which marking is utilized and related factors that may influence the speed, print quality, substrate composition, and ease of manufacturing. By way of example, but not limitation, YAG, YVO4, CO2, UV, IR, argon ion, x-ray laser methods can be employed.

Alternative laser marking systems utilize CO2 lasers with a radiation frequency of 10.6 microns—well into the IR region. Typically, CO2 systems pass the laser light through a mask to shape the image, then focused the image onto the substrate. The CO2 laser is pulsed onto the substrate, resulting in an instantaneous energy buildup in the polymer. “Dot matrix” CO2 laser marking systems find use where the beam is formed into dots that generate the image similar to a dot matrix printer. Continuous beam CO2 lasers are for example utilized as light pens to laser mark.

Alternatively, YAG lasers at 1064 nm wavelength can be used or fiber lasers, which operate at 1064 nm but often require less power/cooling, provide high power density, and long operating lifetimes. The ability to change numerous laser parameters provides advantages compared to CO2 laser systems.

For marking, typically a beam steered laser marking system consists of laser that is focused onto the material to be marked with a large field lens. The beam is steered across the substrate to generate the mark by independent computer-controlled mirrors and galvo laser drive systems.

According to a further aspect, the present invention is also directed to a process for preparing a laser-markable molded body comprising the steps of
(I) providing laser-markable foamed pellets comprising a composition (M1) comprising a thermoplastic elastomer (TPE-1) and a color component (c1) selected from the group consisting of laser marking additives,
(II) fusing the foamed pellets to obtain the molded body.

According to the present invention, according to step (I) of the process, foamed pellets comprising a composition (M1) comprising a thermoplastic elastomer (TPE-1) and a color component (c1) selected from the group consisting of laser marking additives are provided. According to the present invention, the foamed pellets are fused according to step (II). Fusing the foamed pellets is preferably carried out in a mold to shape the molded body obtained. In principle, all suitable methods for fusing foamed pellets can be used according to the present invention, for example fusing at elevated temperatures, such as for example steam chest molding, molding at high frequencies or gluing.

According to a further embodiment, the present invention therefore is directed to the process as disclosed above, wherein step (II) is carried out by thermal fusing or gluing.

The laser-markable molded body obtained according to the present invention can be used for a variety of applications, such as consumer goods, security tags, sports equipment, shoes saddles, toys, pet toys, cushions, or furniture.

The present invention is further illustrated by the following set of embodiments and combinations of embodiments resulting from the dependencies and back-references as indicated. In particular, it is noted that in each instance where a range of embodiments is mentioned, for example in the context of a term such as “any one of embodiments (1) to (4)”, every embodiment in this range is meant to be explicitly disclosed for the skilled person, i.e. the wording of this term is to be understood by the skilled person as being synonymous to “any one of embodiments (1), (2), (3), and (4)”. Further, it is explicitly noted that the following set of embodiments is not the set of claims determining the extent of protection, but represents a suitably structured part of the description directed to general and preferred aspects of the present invention.

An embodiment (1) of the present invention relates to laser-markable foamed pellets comprising a composition (M1) comprising a thermoplastic elastomer (TPE-1) and a color component as component (c1) selected from the group consisting of laser marking additives.

A further preferred embodiment (2) concretizing embodiment (1) relates to said laser-markable foamed pellets, wherein the composition (M1) comprises the color component (c1) selected from the group consisting of laser marking additives in an amount in the range of from 0.1 to 10% by weight, based on the weight of the composition (M1).

A further preferred embodiment (3) concretizing any one of embodiments (1) or (2) relates to said laser-markable foamed pellets, wherein the composition (M1) comprises at least one component (c2) selected from the group consisting of color-change compounds, background colorants, colored pigments and dyes.

A further preferred embodiment (4) concretizing any one of embodiments (1) to (3) relates to said laser-markable foamed pellets, wherein composition (M1) comprises component (c2) in an amount in the range of from 0.1 to 15% by weight, based on the weight of the composition (M1).

A further preferred embodiment (5) concretizing any one of embodiments (1) to (4) relates to said laser-markable foamed pellets, wherein the thermoplastic elastomer is selected from the group consisting of thermoplastic polyurethane, a thermoplastic polyether amide, a polyether ester, a polyester ester, a thermoplastic elastomer based on polyolefin, a crosslinked thermoplastic elastomer based on polyolefin or a thermoplastic vulcanizate or a thermoplastic styrene butadiene block copolymers and mixtures thereof.

A further embodiment (6) of the present invention relates to a process for producing laser-markable foamed pellets of claim 1), the process comprising
(i) mixing a thermoplastic elastomer (TPE-1) and a color component (c1) selected from the group consisting of laser marking additives to obtain a composition (M1) and
(ii) preparing foamed pellets comprising the composition (M1).

A further preferred embodiment (7) concretizing embodiment (6) relates to said process for producing laser-markable foamed pellets, wherein the composition (M1) comprises the color component (c1) selected from the group consisting of laser marking additives in an amount in the range of from 0.1 to 10% by weight, based on the weight of the composition (M1).

A further preferred embodiment (8) concretizing any one of embodiments (6) or (7) relates to said process for producing laser-markable foamed pellets, wherein the composition (M1) comprises at least one component (c2) selected from the group consisting of color-change compounds, background colorants, colored pigments and dyes.

A further preferred embodiment (9) concretizing any one of embodiments (6) to (8) relates to said process for producing laser-markable foamed pellets, wherein composition (M1) comprises component (c2) in an amount in the range of from 0.1 to 15% by weight, based on the weight of the composition (M1).

A further preferred embodiment (10) concretizing any one of embodiments (6) to (9) relates to said process for producing laser-markable foamed pellets, wherein the thermoplastic elastomer is selected from the group consisting of thermoplastic polyurethane, a thermoplastic polyether amide, a polyether ester, a polyester ester, a thermoplastic elastomer based on polyolefin, a crosslinked thermoplastic elastomer based on polyolefin or a thermoplastic vulcanizate or a thermoplastic styrene butadiene block copolymers and mixtures thereof.

A further embodiment (11) of the present invention relates to the use of the laser-markable foamed pellets according to any one of embodiments (1) to (5) for preparing a laser-markable molded body.

A further embodiment (12) of the present invention relates to the use of laser-markable foamed pellets comprising a composition (M1) comprising a thermoplastic elastomer (TPE-1) and a color component as component (c1) selected from the group consisting of laser marking additives for preparing a laser-markable molded body.

A further preferred embodiment (13) concretizing embodiment (12) relates to said use of the laser-markable foamed pellets, wherein the composition (M1) comprises the color component (c1) selected from the group consisting of laser marking additives in an amount in the range of from 0.1 to 10% by weight, based on the weight of the composition (M1).

A further preferred embodiment (14) concretizing any one of embodiments (12) or (13) relates to said use of the laser-markable foamed pellets, wherein the composition (M1) comprises at least one component (c2) selected from the group consisting of color-change compounds, background colorants, colored pigments and dyes.

A further preferred embodiment (15) concretizing any one of embodiments (12) to (14) relates to said use of the laser-markable foamed pellets, wherein composition (M1) comprises component (c2) in an amount in the range of from 0.1 to 15% by weight, based on the weight of the composition (M1).

A further preferred embodiment (16) concretizing any one of embodiments (12) to (15) relates to said use of the laser-markable foamed pellets, wherein the thermoplastic elastomer is selected from the group consisting of thermoplastic polyurethane, a thermoplastic polyether amide, a polyether ester, a polyester ester, a thermoplastic elastomer based on polyolefin, a crosslinked thermoplastic elastomer based on polyolefin or a thermoplastic vulcanizate or a thermoplastic styrene butadiene block copolymers and mixtures thereof.

A further preferred embodiment (17) concretizing any one of embodiments (11) to (16) relates to said use of the laser-markable foamed pellets, wherein the laser-markable body is selected from the group consisting of consumer goods, security tags, sports equipment, shoes saddles, toys, pet toys, cushions, or furniture.

A further preferred embodiment (18) concretizing any one of embodiments (11) to (16) relates to said use of the laser-markable foamed pellets, wherein the laser-markable body is suitable for security applications, in particular security tagging.

A further embodiment (19) of the present invention relates to a process for preparing a laser-markable molded body comprising the steps of
(I) providing laser-markable foamed pellets comprising a composition (M1) comprising a thermoplastic elastomer (TPE-1) and a color component (c1) selected from the group consisting of laser marking additives,
(II) fusing the foamed pellets to obtain the molded body.

A further preferred embodiment (20) concretizing embodiment (19) relates to said process for preparing a laser-markable molded body, wherein step (II) is carried out by thermal fusing or gluing.

A further preferred embodiment (21) concretizing any one of embodiments (19) or (20) relates to said process for preparing a laser-markable molded body, wherein the composition (M1) comprises the color component (c1) selected from the group consisting of laser marking additives in an amount in the range of from 0.1 to 10% by weight, based on the weight of the composition (M1).

A further preferred embodiment (22) concretizing any one of embodiments (19) to (21) relates to said process for preparing a laser-markable molded body, wherein the composition (M1) comprises at least one component (c2) selected from the group consisting of color-change compounds, background colorants, colored pigments and dyes.

A further preferred embodiment (23) concretizing any one of embodiments (19) to (22) relates to said process for preparing a laser-markable molded body, wherein composition (M1) comprises component (c2) in an amount in the range of from 0.1 to 15% by weight, based on the weight of the composition (M1).

A further preferred embodiment (24) concretizing any one of embodiments (19) to (23) relates to said process for preparing a laser-markable molded body, wherein the thermoplastic elastomer is selected from the group consisting of thermoplastic polyurethane, a thermoplastic polyether amide, a polyether ester, a polyester ester, a thermoplastic elastomer based on polyolefin, a crosslinked thermoplastic elastomer based on polyolefin or a thermoplastic vulcanizate or a thermoplastic styrene butadiene block copolymers and mixtures thereof.

A further preferred embodiment (25) concretizing any one of embodiments (19) to (24) relates to said process for preparing a laser-markable molded body, wherein the laser-markable body is selected from the group consisting of consumer goods, security tags, sports equipment, shoes saddles, toys, pet toys, cushions, or furniture.

A further preferred embodiment (26) concretizing any one of embodiments (19) to (25) relates to said process for preparing a laser-markable molded body, wherein the laser-markable body is suitable for security applications, in particular security tagging.

The present invention is further illustrated by the following reference examples, and examples.

### EXAMPLES

1. Extrusion Process

For TPU 1, the expanding process was conducted in a twin-screw extruder of company Krauss Maffai (ZE 40). Table 1 show the composition of the used TPU and additives.

TABLE 1
Composition of the thermoplastic polyurethanes used for examples

| | | Additive | Additive | Additive |
|---|---|---|---|---|
| compounds used | TPU 1 | 2 | 3 | 4 |
| polyether polyol with an OH-number of 112 and only | 1000 | | | |
| primary OH— groups (based on tetramethylene oxid, | | | | |
| functionality: 2) (parts per weight) | | | | |
| aromatic isocyanate (4,4′ methylendiphenyldiisocyanate) | 520 | | | |
| (parts per weight) | | | | |
| 1,4-butane diol [parts per weight] | 97 | | | |
| Stabilizer Package | 25 | | | |
| tin-II-isooctoate (50% in dioktyladipate) (parts per | 50 | | | |
| weight) | | | | |
| Mica coated with antimon-doped tin oxide (%) | | 4.5 | | |
| Copper Hydroxide Phosphate (%) | | 24.5 | | |
| Ester of mixed montanic acids (%) | | 1 | | |
| E 1185 A 10 000 (%) | | 70 | | |
| Color masterbatches by company Grafe (visible | | | TPU | TPU- |
| colorants) | | | Tekolen | Tekolen |
| | | | Grün | Leucht |
| | | | Gold | orange |
| | | | (color: | RAL |
| | | | green- | 2005 |
| | | | gold) | (color: |
| | | | | lightning |
| | | | | orange) |

The material was dried for minimum 5 h at 70° C. directly before extrusion. If necessary different amounts of a TPU which was compounded in a separate extrusion process with 4,4-Diphenylmethandiisocyanat with a functionality of 2.05 (additive 1) was added during processing. The temperature range of the extruder was 200° C. Laser suitable pigments (additive 2 (corresponding to component c1)) have been added in various amounts as masterbatch with a pigment content of 30% (Examples 1 to 3). As blowing agent CO₂ and N₂ was injected into the melt and all added materials were mixed homogeneously with the thermoplastic polyurethane. Table 2 shows the different compositions of example 1-3 and the reference example 1.

TABLE 2
Process details of eTPU extrusion processing step

| | | Example | | Reference |
|---|---|---|---|---|
| eTPU | Example 1 | 2 | Example 3 | example 1 |
| TPU | TPU 1 | TPU 1 | TPU 1 | TPU 1 |
| Content of TPU (% b.w.) | 96.4 | 93.4 | 89.4 | 99.4 |
| Content of additive 1 (% b.w.) | 0.6 | 0.6 | 0.6 | 0.6 |
| Content of additive 2 (% b.w.)/Laser | 3 (~1.0% | 6 (~2.0% | 9 (~3.0% | — |
| suitable pigment concentration in % | laser pig- | laser | laser pig- | |
| b.w.) | ment) | pigment) | ment) | |
| Particle mass (mg) | 5 | 5 | 5 | 5 |
| Bulk density (g/L) | 171 | 175 | 179 | 165 |
| CO₂ (Gew. %) | 2.6 | 2.6 | 2.6 | 2.6 |
| N₂ (Gew. %) | 0.1 | 0.1 | 0.1 | 0.1 |
| Pressure in UWP (bar) | 15 | 15 | 15 | 15 |
| Temperature in UWP(° C.) | 40 | 40 | 40 | 40 |

After mixing of all components in the extruder the material was first pressed through a gear pump with a temperature of 190° C. and then through a die plate heated up to 190° C. The granulate was cut and formed in the underwater pelletizing system (UWP). During the transport out of the UWP the particles expands under defined conditions of temperature and pressure of the water. Before drying the material for 5 h at 50° C. a centrifugal drier was used for separating the granulate and the water.

After drying, the bulk density of the resulting foamed beads is measured (according to DIN ISO 697:1984-01).

Process details of all different examples and reference examples like the used water temperatures and -pressure, the amount of blowing agents CO₂ and N₂ as well as the particle mass and resulting bulk density are listed in table 2.

2. Autoclave Process & Colored Particle Foam

To further illustrate the invention, colored particle foams were produced (see Example 4, Example 5 and reference example 2). Also dyed particle foams were laser-marked if standard laser energy was used (Example 4, Example 5). The use of higher laser energy resulted in poor intensity and destruction of the 3D structure of the foam surface (reference example 2).

For the examples, the inventive TPU 1 was mixed in a pre-process step, in a twin-screw extruder of company Krauss Maffai (ZE 40) with laser suitable pigments (additive 2) and different color masterbatches provided of company Grafe (additive 3 and 4) (Example 4 and 5) (table 3). The particle mass is 25 mg.

TABLE 3
Composition and properties of TPU compounds

| TPU | TPU 2 | TPU 3 |
|---|---|---|
| Content of TPU 1 (% b.w.) | 93 | 90 |
| Content of additive 2 (% b.w.)/ | 4 (1.3% | 4 (1.3% laser |
| Laser suitable pigment concentra- | laser pig- | pigment) |
| tion in & % b.w. | ment) | |
| Content of additive 3 (% b.w.) | 3 | — |
| Content of additive 4 (% b.w.) | — | 6 |
| Particle mass (mg) | 25 | 25 |
| Density (kg/m³) | 1100 | 1100 |

Experiments were conducted in a closed pressure vessel (Impregnation vessel) at a filling level of 80% by volume.

100 parts by weight of particles from TPU 2 or 3 of table 3 and certain amounts (parts by weight) of water (333 parts by weight) as suspension medium which results in a phase re lationship P1 are mixed by stirring to get a homogenous suspension. Phase relationship P1 is defined as weight of solid particles divided by weight of water, 6.7% by weight, based on the solid particles, of a dispersing agent (surfactant 1), together with 0.13% by weight of an assistant system (surfactant 2) based on the solid particles and a certain amount of butane as blowing agent, based on the solid particles, are added to the suspension and heated up during further stirring.

At 50° C., nitrogen as co-blowing agent was added by pressure increase, to a predetermined pressure within the vessel. The liquid phase of the suspension was heated to the predetermined impregnation temperature (IMT). The time (soaking time) between 5° C. below IMT until IMT is controlled to be within 3 min and 60 min. This correlates with a heating rate of 1.67° C./min until 0.083° C./min.

In this procedure, at IMT a defined pressure in gaseous phase (IMP) is formed.

After soaking time and at the reached IMT, the pressure was released and the whole content of the vessel (suspension) was poured through a relaxation device into a vessel under atmospheric pressure (expansion vessel). Expanded beads are formed.

During the relaxation step, the pressure within the impregnation vessel was fixed with nitrogen to a certain level (squeezing pressure SP).

Additionally, directly after the relaxation device, the expanding particles can by cooled by a certain flow of water with a certain temperature (water quench).

After removal of the dispersing agent and/or the assistant system (surfactant) and subsequent drying, the bulk density of the resulting foamed beads is measured (according to DIN ISO 697:1984-01).

Details concerning manufacturing parameters of individual example and reference example are listed in table 5.

TABLE 5
Data for the manufacturing expanded beads

| | | | Reference |
|---|---|---|---|
| eTPU | Example 4 | Example 5 | example 2 |
| TPU | TPU 2 | TPU 3 | TPU 3 |
| Dispersing agent (surfactant 1) | CaCO₃ | CaCO₃ | CaCO₃ |
| Assistant system (surfactant 2) | L | L | L |
| Phase relationship P1 | 0.3 | 0.3 | 0.3 |
| Butane (% b.w.) | 24 | 24 | 24 |
| p after adding N₂ at 50° C. (bar) | 8 | 8 | 8 |
| Soaking time (min) | 4 | 4 | 4 |
| IMT (° C.) | 117 | 117 | 117 |
| SP (MPa) | 4.0 | 4.0 | 4.0 |
| Water quench | No | No | No |
| Bulk density (kg/m³) | 115 | 120 | 120 |

3. Steam Chest Molding & Mechanics

In a next step the expanded material was molded to quadratic test plates with a length of 200 mm×200 mm and thickness of 10 mm using steam chest molding machine of company Kurtz ersa GmbH (Boost Foamer K68). The molding parameter were adjusted for smaller (example 1-3, reference example 1) and bigger beads (example 4-5, reference example 2). Additionally, the crack steam was carried out by the movable side of the tool. The molding parameters are listed in table 6.

TABLE 6
Processing conditions for steam chest molding of examples

| | | | Ex. 4-5 |
|---|---|---|---|
| | | Ex. 1-3 and | and refer- |
| | | reference | ence ex- |
| Example | Unit | example 1 | ample 2 |
| Crack size | mm | 14 | 14 |
| Crack steam fixed side | bar | — | — |
| Crack steam fixed side | s | — | — |
| Crack steam movable side | bar | 0.3 | 0.6 |
| Crack steam movable side | s | 10 | 16 |
| Cross steam fixed side/counter pressure | bar | 1.3/0 | 1.3/0 |
| Cross steam fixed side/counter pressure | s | 10/0 | 30/0 |
| Cross steam movable side/counter pressure | bar | — | — |
| Cross steam movable side/counter pressure | s | — | — |
| Autoclave steam fixed/movable side | bar | 1.3/0.8 | 1.3/0.8 |
| Autoclave steam | s | 10 | 10 |

Lasering of the material was done with a TruMark 6030 (TTM2) at a wavelength of 1064 nm. The evaluation of the lasering results are shown in table 7. The rating differentiates between the color intensity as well as the effect on the 3D surface. Additionally, the pigment content and laser energy which was used for printing on the surface is written down in the table.

TABLE 7
Evaluation of laser test results; +good, ++better, −bad, −−worse

| | | Laser | Intensity | 3D |
|---|---|---|---|---|
| | Additive 2 | Energy | of marking | Surface |
| Example 1 | 3% | Standard | + | ++ |
| Example 2 | 6% | Standard | ++ | ++ |
| Example 3 | 9% | Standard | ++ | ++ |
| Reference example 1 | 0% | Standard | −− | ++ |
| Example 4 | 4% | Standard | + | ++ |
| Example 5 | 4% | Standard | + | ++ |
| Reference example 2 | 4% | Higher | − | −− |

Literature Cited:
WO 94/20568 A1
WO 2007/082838 A1
WO 2017/030835 A1
WO 201 3/1 531 90 A1,
WO 201 0/01 001 0 A1
WO 01/00719 A1
EP 1 190 988 A1
DE 38 42 330 A1
F. Buchholtz et al., Macromolecules, vol. 26, p. 906 (1993)
U.S. Pat. No. 5,989,573
EP 0 359 909 B1
“Handbook of Thermoplastic Elastomers”, 2nd edition June 2014
WO2018087362A1
Plastics Additives Handbook, 5th edn., H. Zweifel, ed., Hanser Publishers, Munich, 2001 ([1]), pp. 98-136

1. Laser-markable foamed pellets, comprising:
a composition (M1) comprising
a thermoplastic elastomer (TPE-1), and
a color component (c1) selected from laser marking additives,
wherein the composition (M1) comprises the color component (c1) in an amount in a range of from 0.1 to 10% by weight, based on a weight of the composition (M1).

2. The laser-markable foamed pellets according to claim 1, wherein the composition (M1) comprises at least one component (c2) selected from the group consisting of a color-change compound, a background colorant, a colored pigment, and a dye.

3. The laser-markable foamed pellets according to claim 2, wherein the composition (M1) comprises the at least one component (c2) in an amount in a range of from 0.1 to 15% by weight, based on the weight of the composition (M1).

4. The laser-markable foamed pellets according to claim 1, wherein the thermoplastic elastomer (TPE-1) is selected from the group consisting of thermoplastic polyurethane, a thermoplastic polyether amide, a polyether ester, a polyester ester, a thermoplastic elastomer based on polyolefin, a crosslinked thermoplastic elastomer based on polyolefin, a thermoplastic vulcanizate, a thermoplastic styrene butadiene block copolymer, and a mixture thereof.

5. The laser-markable foamed pellets according to claim 1, wherein the thermoplastic elastomer (TPE-1) is a thermoplastic polyurethane, a thermoplastic polyether amide, a polyester ester, or a polyether ester.

6. A process for producing the laser-markable foamed pellets of claim 1, the process comprising:
(i) mixing the thermoplastic elastomer (TPE-1) and the color component (c1), to obtain the composition (M1), and
(ii) preparing the laser-markable foamed pellets comprising the composition (M1),
wherein the composition (M1) comprises the color component (c1) in an amount in the range of from 0.1 to 10% by weight, based on the weight of the composition (M1).

7. A laser-markable molded body, comprising the laser-markable foamed pellets according to claim 1.

8. The laser-markable molded body according to claim 7, wherein the laser-markable molded body is selected from the group consisting of a consumer good, a security tag, sports equipment, a shoe, a saddle, a toy, a pet toy, a cushion, and furniture.

9. (canceled)

10. A process for preparing a laser-markable molded body, the process comprising:
(I) providing laser-markable foamed pellets comprising
a composition (M1) comprising
a thermoplastic elastomer (TPF-1), and
a color component (c1) selected from laser marking additives,
wherein the composition (M1) comprises the color component (c1) in an amount in a range of from 0.1 to 10% by weight, based on a weight of the composition (M1), and
(II) fusing the laser-markable foamed pellets to obtain the molded body.

11. The process according to claim 10, wherein (II) is carried out by thermal fusing or gluing.
